(19) United States
(12) Patent Application Publication
(10) Pub. No.: US 2004/0163558 A1
(43) Pub. Date: Aug. 26, 2004

(54) Paper-like material conveying apparatus, paper-like material conveying direction switching apparatus and paper-like material stamping apparatus

(75) Inventors: Shinichi Itoh, Kanagawa-ken (JP); Naruaki Hiramitsu, Kanagawa-ken (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/779,768

(22) Filed: Feb. 18, 2004

(30) Foreign Application Priority Data
Feb. 25, 2003 (JP) 2003-047734
Sep. 8, 2003 (JP) 2003-315879
Oct. 15, 2003 (JP) 2003-355409

(51) Int. Cl. B41F 13/24

(52) U.S. Cl. 101/232

(57) ABSTRACT

The conveying apparatus has drive rollers and driven rollers that are opposing each other with the conveying path put between them. The driven rollers are in the dual layers structure comprising rubbers and sponges and are arranged rigidly to the drive rollers that are rigidly arranged at a prescribed center distance. When postal matters are rushed into the nips, the driven rollers are elastically deformed to follow the postal matters.

### CROSS-REFERENCE TO RELATED APPLICATIONS

This application is based upon and claims the benefit of priority from prior Japanese Patent Application No. 2003-47734, filed Feb. 25, 2003, No. 2003-315879, filed Sep. 8, 2003, and No. 2003-355409, filed Oct. 15.

### BACKGROUND OF THE INVENTION

1. Field of the Invention

This invention relates to a paper-like material conveying apparatus to convey paper-like materials in different thickness, a paper-like material conveying direction switching apparatus to reverse the conveying direction of paper-like materials in different thickness, and a paper-like material stamping apparatus to stamp paper-like materials in different thickness, and particularly relates to a paper-like material conveying apparatus, a paper-like material conveying direction switching apparatus and a paper-like material stamping apparatus to process paper-like materials in different thickness such as postal matters, bankbooks, etc.

2. Description of the Related Art

A separation apparatus to take out copy paper from a paper cassette one by one in a copier is known as an apparatus to process paper-like materials by pinching them with a pair of rollers as disclosed in the Japanese Patent Disclosure No. 8-99734. This apparatus uses elastic rollers that are in the three-layer structure as paper separation rollers.

These elastic rollers are in such structure that, for instance, a porous resin layer is formed for the first layer on the roller shaft, an impregnated resin coated layer is formed for the second layer, and a coating resin layer is formed for the third layer. These elastic body rollers are arranged near the end of a paper supply cassette by pressure fitting to the paper feeding rollers. Plural sheets of copy paper are separated and taken out one by one by rotating the elastic rollers in the direction reverse to the copy paper take-out direction while rotating the feeding roller in the copy paper take-out direction.

However, the elastic roller described above is designed for the purpose of taking out thick copy paper uniformly from a paper supply cassette by separating sheets one by one and is not designed by assuming to clamp and convey paper-like materials in different thickness such as postal matters, bankbooks, etc. Therefore, for example, even when these elastic rollers are adopted for a postal matter processing apparatus, the rollers are not able to correspond to change in thickness of postal matters and do not function normally.

Further, a conventional conveying apparatus 100 shown in FIG. 1 has a drive roller 101 arranged rigidly at the underside of a conveying path 2 and a driven roller 102 arranged at the upper side of conveying path 2. Driven roller 102 is attached rotatably to the end of an arm 104 that is rotatably attached to a frame and pressed by a spring 106 toward drive roller 101.

Therefore, when especially thick or heavy postal matters are conveyed along conveying path 2 at a relatively high velocity and rushed into a nip 103 formed between two rollers 101 and 102, driven roller 102 leaps up by the shock. By this leap-up, proper thrusting pressure is not given, the conveying force drops as shown by a waveform in FIG. 1 and fluctuation in conveying velocity or conveying jam may be caused. Especially, when postal matters P are successively conveyed at a certain interval, the conveying interval may become short and the process may be disabled. When the pinching pressure is increased in order to restrain this problem, there will be such problems as the life of drive roller 101 is remarkably reduced or postal matters P may be damaged.

Further, a paper-like material take-out apparatus to take out paper-like materials by separating them one by one is known as an apparatus to take out stacked paper-like materials on a conveying path as shown in the Japanese Patent Disclosure No. 2003-109061. This apparatus has a pick-up roller to contact paper-like materials at one end in the stacking direction and a separating portion to separate the taken out paper-like materials one by one by rotating the pick-up roller. The separation portion has a take-out roller arranged at one side of a conveying path and a reversing roller pressed by the take-out roller through the conveying path.

At the further downstream side of the separation portion along the paper-like material take-out direction, there is a drive roller. A pinch roller is arranged to the drive roller under pressure through the conveying path. The pinch roller is compressed to the drive roller by a spring.

When paper-like materials are taken out on the conveying path by operating this paper-like take-out apparatus, paper-like materials that are separated one by one through the separation portion are rushed into a nip between the drive roller and the pinch roller. When the paper-like materials taken out are relatively thick and heavy at this time, they strike up the pinch roller. When the pinch roller leaps up, the conveying of the paper-like materials cannot be controlled as long as the pinch roller leaps up, and skew or shift is caused and the gap cannot be controlled.

### SUMMARY OF THE INVENTION

It is an object of this invention to provide a paper-like material conveying apparatus, a paper-like material conveying direction switching apparatus and a paper-like material stamping apparatus.

According to this invention, there is provided a paper-like material conveying apparatus comprising a drive roller which is given with a driving force, rotated and driven; and a driven roller arranged rotatably following the rotation of the drive rollers, the driven roller including a first layer formed with a solid elastic material that is in contact with the drive roller and a second layer formed with a foam elastic material that is formed at the inside from the first layer, wherein paper-like materials conveyed into the nip between the drive roller and the driven roller are pinched, conveyed and carried out.

Further, according to this invention, there is provided a paper-like material conveying direction switching apparatus comprising a drive roller which is given with a drive force, rotated and driven in both the forward and reverse directions; and a driven roller arranged rotatably following the rotation of the drive rollers, the driven roller including a first layer formed with a solid elastic material that is in contact with the drive roller and a second layer formed with a foam elastic material that is formed at the inside from the first layer, wherein paper-like materials in non-uniform thickness conveyed into the nip between the drive roller and the driven roller are pinched, conveyed and stopped and then, the drive roller is counter-rotated and the paper-like materials are carried out in the reverse direction.

Further, according to this invention, there is provided a paper-like material stamping apparatus comprising a cylindrical stamp having a convex plate on the outer surface, which is given with a driving force and rotates; an ink supply portion to supply ink to the outer surface of the cylindrical stamp; and a platen roller arranged on the outer surface of the cylindrical stamp in the non-contact state via a prescribed gap, the platen roller including a first layer formed with a solid elastic material and a second layer formed with a foam elastic material that is formed at the inside from the first layer, and the platen roller being given with a driving force and rotated in the same direction as the cylindrical stamp, wherein a mark is stamped on the surfaces of paper-like materials in non-uniform thickness carried into the gap by contacting and rotating the cylindrical stamp thereon.

In addition, according to this invention, there is provided a paper-like material conveying apparatus comprising plural drive rollers to contact the same surfaces of paper-like materials taken out on a conveying path and rotate in the conveying direction at the same peripheral velocity; and plural driven rollers rigidly arranged in contact with plural drive rollers rotatably following the rotation of the drive rollers, respectively through the conveying path and allow to accept paper-like materials conveyed into nips between the driven rollers and the opposed drive rollers by elastically deforming and rotate independently each other.

Further, according to this invention, there is provided a paper-like material conveying direction switching apparatus comprising plural drive rollers which contact the same surfaces of paper-like materials taken out on a conveying path and rotate in the same direction at the same peripheral velocity; and plural driven rollers which are arranged rigidly to contact the plural drive rollers through the conveying path, rotatably following the rotation of the drive rollers, allow to accept paper-like materials to the nips between the driven rollers and the opposed drive rollers by elastically deforming and rotate each other independently, wherein paper-like materials conveyed into the plural nips are conveyed while pinched and stopped and then, the plural drive rollers are counter-rotated and the paper-like materials are carried out in the reverse direction.

### BRIEF DESCRIPTION OF THE DRAWINGS

FIG. 1 is a schematic front view showing a conventional conveying apparatus with a driven roller pinch compressed and fitted to a drive roller;

FIG. 2 is a schematic front view showing a conveying apparatus involved in a first embodiment of this invention;

FIG. 3 is a perspective view showing an enlarged driven roller incorporated in the conveying apparatus shown in FIG. 2;

FIG. 4 is a schematic diagram for explaining the behaviors of a postal matter put into a nip and the driven roller;

FIG. 5 is a table showing coefficients of dynamic friction, rubber thickness, sponge hardness and the like of a driven roller that was tested;

FIG. 6 is a graph showing the results of paper-like material conveying tests using the conveying apparatus shown in FIG. 2 and the conveying apparatus shown in FIG. 7;

FIG. 7 is a graph showing the results of paper-like material conveying tests using the conveying apparatus shown in FIG. 2;

FIG. 8 is a schematic front view showing the conveying direction switching apparatus involved in a second embodiment of this invention;

FIG. 9 is a graph showing the paper-like material conveying rest result using the conveying direction switching apparatus shown in FIG. 8 and a conventional apparatus;

FIG. 10 is a graph showing the paper-like material conveying test result using the conveying direction switching apparatus shown in FIG. 8;

FIG. 11 is a schematic front view showing the stamping apparatus involved in a third embodiment of this invention;

FIG. 12 is a graph showing the paper-like material conveying test results shown in FIG. 11;

FIG. 13 is a graph showing the paper-like material conveying test results using the stamping apparatus shown in FIG. 11;

FIG. 14 is a schematic front view showing the conveying apparatus involved in a fourth embodiment of this invention;

FIG. 15 is a side view of the conveying apparatus showing in FIG. 14;

FIG. 16 is a schematic front view showing the conveying direction involved in a fifth embodiment of this invention; and

FIG. 17 is a side view of the conveying direction switching apparatus shown in FIG. 16.

### DETAILED DESCRIPTION OF THE INVENTION

Embodiments of this invention will be described below in detail referring to attached drawings.

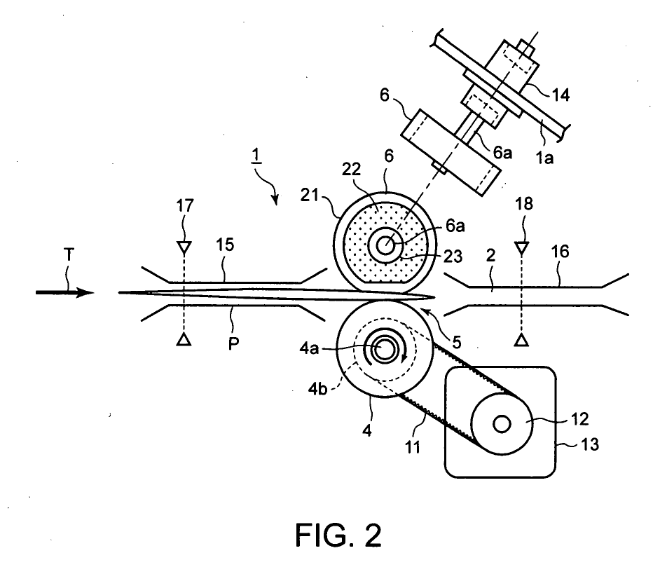

FIG. 2 shows a schematic structure of a conveying apparatus 1 (paper-like material conveying apparatus) involved in a first embodiment of this invention. This conveying apparatus will be explained here taking such postal matters P as 0.15 to 6 mm thick envelops, postcards, envelops containing photographs, vinyl envelops as examples. Further, the using ambient temperature of this conveying apparatus 1 was assumed at 0 to 40° C.

Conveying apparatus 1 has a conveying path 2 for conveying postal matters P in the direction of an arrow mark T in FIG. 2, a drive roller 4 arranged at one side of conveying path 2 (the lower side in FIG. 2), and a driven roller 6 arranged at the other side of conveying path 2 (the upper side in the figure). Driven roller 6 is arranged at a position opposing to drive roller 4 via conveying path 2 and deformed as press fit to drive roller 4.

A rotational shaft 4a of drive roller 4 is attached to a frame 1a of conveying apparatus 1 rotationally and rigidly. An endless timing belt 11 is wound round a pulley 4b that is fixed to rotational shaft 4a of drive roller 4. Timing belt 11 is connected to a motor 13 via a pulley 12. When motor 13 is driven, drive roller 4 is rotated in the arrow mark direction (the clockwise direction) in FIG. 2 at a specified speed.

Rotational shaft 6a of driven roller 6 is installed to frame la rotatably and rigidly. That is, rotational shaft 6a is attached with a housing 14 that has plural bearings (not shown) and this housing 14 is rigidly attached to frame 1a. Driven roller 6 is in contact with drive roller 4 and rotated following the rotation of drive roller 4.

The center distance of drive roller 4 and driven roller 6 is so set that both are press fit via conveying path 2. That is, because two rollers 4 and 6 are arranged rigidly against frame 1a, a thrusting force is produced between them when driven roller 6 is elastically deformed as shown.

In this embodiment, the center distance is set so that a deformed amount of driven roller 6 becomes 0.5 mm in the state where drive roller 4 and driven roller 6 are press fit. This deforming amount denotes a length of the center distance that is made short from the contacting state of two rollers 4 and 6.

Before and after a nip 5 between drive roller 4 and driven roller 6, there are two sets of guide plates 15 and 16 to guide postal matters P along conveying path 2. Further, at the upstream side and the downstream side of nip 5 along the conveying direction of postal matters P, there are sensors 17 and 18 for detecting passing of postal matters P.

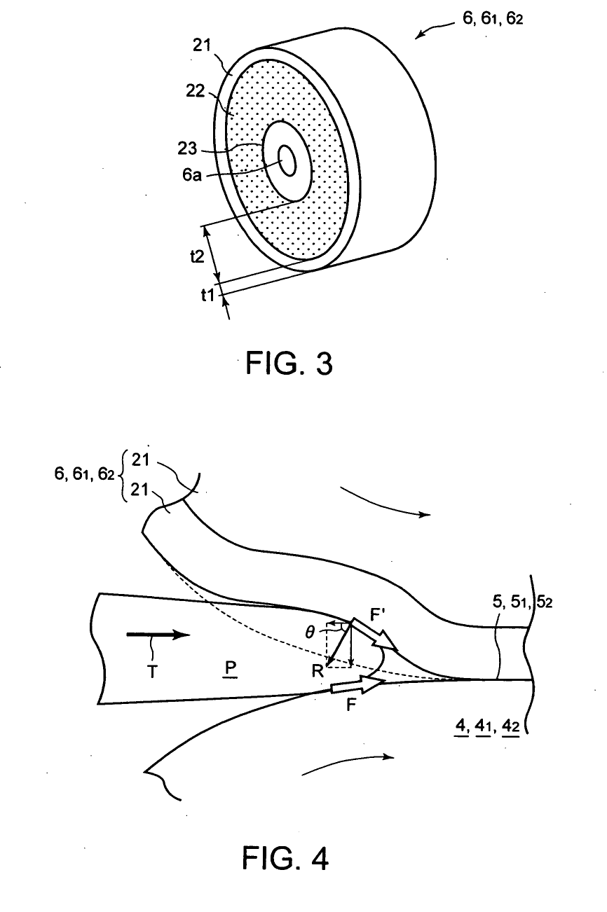

Driven roller 6 has an elastic dual layer structure. A first layer at the outside contacting drive roller 4 is formed by a rubber 21 (a solid elastic material) and a second layer at the inner side is formed by a sponge 22 (a foam elastic material) as shown in an enlarged view in FIG. 3.

In this embodiment, an aluminum core metal 23 is provided at the outside of rotational shaft 6a and sponge 22 is provided at the outside of core metal 23. LL Rubber B type (an independent foam urethane sponge) manufactured by Kyowa Giken Co., Ltd. was adopted for sponge 22. This independent foam urethane sponge has a compression set less than 3% specified in JIS K 6254, a tear strength more than 2 kN/m specified in JIS K 6252, and Asker C Hardness 30 (equal to JIS K 6523 type). Rubber 21 is provided at the outside of sponge 22. This rubber 21 is HAN60 (natural rubber) manufactured by Hitachi Cable Ltd.) and its rubber hardness is 60 (JIS K 6253 A type).

It is known that coefficient of rubber generally varies depending upon mating material, ambient temperature and relative velocity and it is necessary to take these conditions into consideration sufficiently when selecting rubber 21. When assuming a working ambient temperature at 0 to 40° C. and various kinds of envelops, postcards, envelops containing photographs, vinyl envelops, print coated paper, etc. for postal matters as in this embodiment, coefficient of dynamic friction more than 0.8 in a range of relative velocity less than 200 mm/s can be maintained for an extended period when the above-mentioned HAN60 manufactured by Hitachi Cable Ltd. is used. Further, NBR series (nitrile rubber system) manufactured by Hokushin Corporation may be used in addition to HAN60 as materials for rubber 21. For sponge 22, Urethane Sponge No. 15 manufactured by Hokushin Corporation is also usable.

Further, when driven roller 6 is manufactured, the surface roughness of core metal 23 is increased by the sand blast processing and sponge 22 is bonded to the outer surface of core metal 23 using a vulcanizing agent in this embodiment. In this bonding, such elastic bonding agents as epoxy bonding agent such as Araldite, PM155 manufactured by Cemedine Co. Ltd. may be used. Further, rubber 21 was bonded to the outer surface of sponge 22 using a bonding agent; that is, Tyrite 7650 (“Tyrite” is the trademark of Lord corporation) used jointly with Chemlok 7701 (a primer agent) (“Chemlok” is the trademark of the Lord Corporation). This bonding agent may be used for bonding sponge 22 and core metal 23.

As a cheap bonding method somewhat sacrificing durability, sponge 22 may be fitted into core metal 23 by making the outer diameter of core metal 23 larger than the inner diameter of sponge 22 by about 10% without using a bonding agent for fixing core metal 23 and sponge 22.

Further, in this embodiment the thickness t1 of rubber 21 was 2 mm, thickness t2 of sponge 22 was 13 mm, the diameter of core metal 23 was 20 mm and the diameter of driven roller 6 was 50 mm. Further, the width of driven roller 6 was 15 mm. Also, drive roller 4 was formed with the same rubber material as that of rubber 21 of driven roller 6.

Because driven roller 6 is arranged rigidly to drive roller 4 in the press fit state as described above, driven roller 6 does not leap up from conveying path 2 when a postal matter P is rushed into nip 5. That is, driven roller 6 is deformed corresponding to the thickness of a postal matter P as shown in FIG. 3 and conveys a postal matter P passing through nip 5 by pinching while constantly applying a thrusting force to a postal matter P. Therefore, the conveying force of drive roller 4 is effectively transmitted to a postal matter P and variation of conveying velocity of a postal matter P is suppressed.

The behavior of driven roller 6 and a postal matter P when a postal matter P is rushed into nip 5 will be reviewed referring to FIG. 4. Further, in the state before a postal matter P arrives at nip 5, driven roller 6 is in contact with drive roller 4, a driving force is transmitted from the drive roller 4 and driven roller 6 is rotating in the direction of the arrow mark shown in FIG. 4 following the rotation of the drive roller 4.

When a postal matter P is rushed into nip 5, driven roller 6 is crushed and a postal matter P is gradually pinched between driven roller 6 and drive roller 4. At this time, driven roller 6 gives a vertical force R from the roller surface to the postal matter P. Therefore, a reaction force R sin θ to push a postal matter P back in the conveying direction (the direction of arrow mark T in FIG. 4) is acted to the postal matter P. The more a postal matter P is thick, the more this reaction force R sin θ becomes large.

By the way, a postal matter P is conveyed in the arrow direction T by the conveying force F based on the rotation of drive roller 4 and the conveying force F″ based on the rotation (the driven rotation) of driven roller 6. Therefore, if a resultant force of the conveying forces F and F′ acting on a postal matter P was sufficiently larger than the reaction force R sin θ, a postal matter P is normally conveyed but if the conveying forces F and F′ become small, the conveying becomes defective.

That is, when a coefficient of dynamic friction of drive roller 4 and that of driven roller 6 are low, the conveying forces F and F′ become small and the influence of the reaction force R sin θ becomes large. Therefore, in order to convey a postal matter P normally, it is necessary to make conveying forces F and F′, that is, coefficients of dynamic friction of rollers 4 and 6 to a postal matter P large as could as possible.

Further, in addition to make a coefficient of dynamic friction large, a method to make elasticity of driven roller 6 weak is also considered so as to make the reaction force R sin θ small to obtain the normal conveying performance. According to the results of tests that will be described later, a good result was obtained when a sponge having a compression set less than 5% specified in JIS K 6254, Asker C (or JIS K 6253 type) hardness less than 40 and the thickness t2 more than 1.8 times of the most thick postal matter P (6 mm in this embodiment) of postal matters subject to process was used as sponge 22 that governs elasticity of driven roller 6.

The compression set of sponge 22 largely affects the maintenance of the performance to deform following a postal matter P. When the compression set specified in JIS K 6254 exceeds 5%, the permanent set results by a load caused from a thrusting force when not operated and a load when conveying especially thick postal matters P and the sponge could not be kept in the circular shape. As a result, a required thrusting force could not be given to especially thin postal matters P and postal matters could not be conveyed normally.

Further, hardness and thickness of sponge 22 become conditions required for obtaining the deforming performance following to postal matters P and proper thrusting force by their interaction. When hardness is too high or thickness is too thin, the following deformation becomes difficult, defective conveying results or postal matters P and drive roller 4 (including peripheral members) may be damaged.

That is, in order to convey postal matters P normally by conveying apparatus 1 described above, it is necessary to set a coefficient of dynamic friction, hardness, thickness and compression set of driven roller 6 at proper values. Inventor, et al. found these proper values by conducting tests described below. Driven roller 6 in the above-mentioned first embodiment is a roller achieved the proper values.

In the tests, 1,000 postal matters P in the thickness of 0.15 to 6 mm, the weight range of 2 to 60 g (thickness and weight were allocated so that thick postal matters become equivalent to heavy postal matters) were provided as test articles. These 1,000 postal matters were conveyed successively through the above-mentioned conveying apparatus 1 at a conveying velocity 3.6 m/s and a conveying interval 100 mm, and a deviation (standard deviation) in the conveying interval among postal matters passed through conveying apparatus 1 was checked. The conveying interval was measured based on a time difference to detect the passage of a postal matter P by sensors 17 and 18 arranged before and behind nip 5.

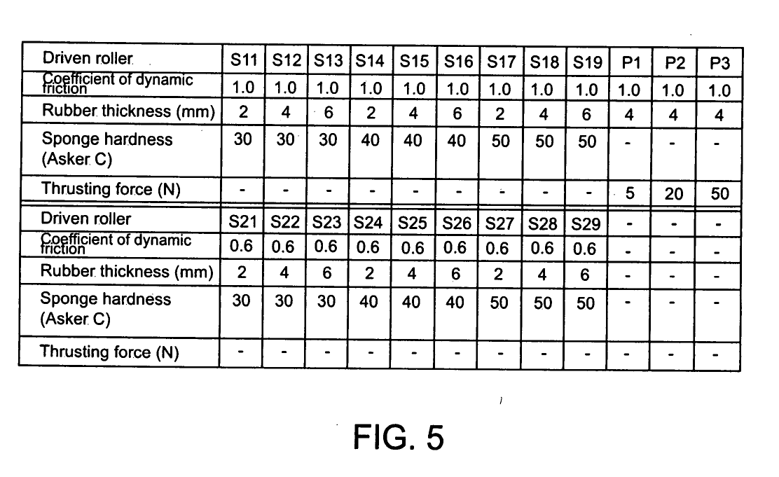

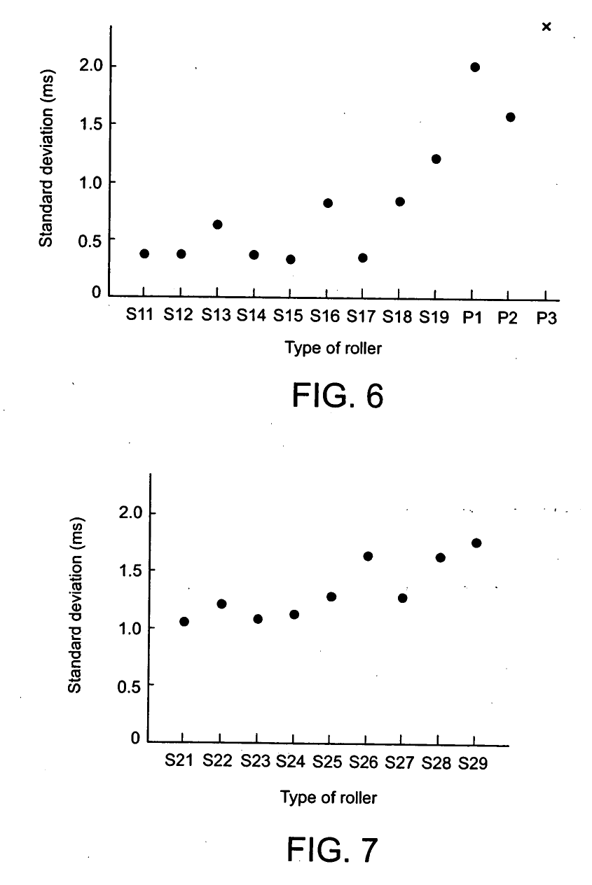

Further, in this test in order to check the proper values mentioned above, several kinds of driven rollers 6 with coefficient of dynamic friction, thickness of rubber 21 and hardness of sponge 22 changed variously were provided, the above-mentioned conveying tests were conducted by setting driven rollers in conveying apparatus 1. Coefficient of dynamic friction, rubber thickness and sponge hardness of respective driven rollers 6 (S11 to S19, S21 to S29) that were used in this test are tabulated and shown in FIG. 5. Test results when driven rollers 6 were used are shown in graphs in FIG. 6 and FIG. 7. The ordinates of the graphs show standard deviations that are variance in the conveying intervals when driven rollers 6 were used. That is, it shows that the more the standard deviation is large, the more variance is large.

As HAN60 rubber 21 manufactured by Hitachi Cable Ltd. (a coefficient of dynamic friction more than 0.7 can be obtained even at an ambient temperature 0° C.) was used as shown in FIG. 5, a coefficient of dynamic friction of driven rollers S11 to S19 is 1.0. For driven rollers S21 to S29, an n urethane rubber having a coefficient of dynamic friction about 0.6 was used for rubber 21. Further, the outer diameter of driven rollers S11 ˜S19 and S31 to S20 was unified at 50 mm and the diameter of core metal 23 was unified at 20 mm.

In the following, the rest results will be considered.

The standard deviation of five driven rollers S11, S12, S14, S15 and S17 is about 0.5 ms as shown in FIG. 6 and a good result is presented. The thickness of rubber 21 of these driven rollers is all less than 4 mm. That is, the thickness of sponge 22 (15 to 4 mm) against maximum 6 mm thick postal matters is more than 1.8 times and the thickness of rubber 21 is less than ½ of the thickness of sponge 22.

On the contrary, the thickness of rubber 21 of three driven rollers S13, S16 and S19 is 6 mm and does not satisfy the above-mentioned conditions. Therefore, when conveying a relatively thick postal matter P, the driven roller could not deform following the postal matter P and a variance of conveying interval was generated, and the standard deviation of these driven rollers was larger than the above-mentioned five driven rollers S11, S12, S14, S15 and S17. In particular, from the detailed analysis it is seen that this standard deviation becomes remarkably large according to thickness of postal matter P.

Further, although driven roller S18 has rubber 21 that is 4 mm thick and clears the required condition, sponge 22 has a relatively higher hardness of Asker C 50 and driven roller S18 could not deform following a postal matter P. That is, even when the thickness of rubber 21 is made thin, driven roller S18 cannot deform following a postal matter P when the hardness of sponge 22 becomes hard and it is seen that the defective conveyance results anyway.

From the above results, it is seen that thickness t2 of sponge 22 of 1.8 times of the maximum thickness of postal matter, thickness t1 of rubber 21 below ½ of thickness t2 of sponge 22 and hardness of sponge 22 below 40 are needed to obtain a good conveying performance.

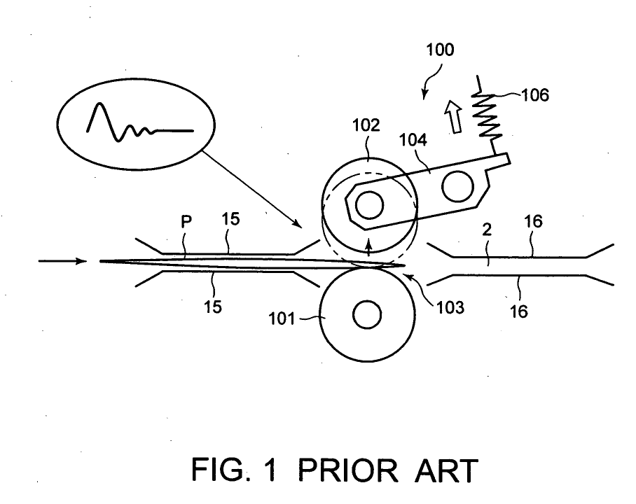

In FIG. 5 and FIG. 6, driven rollers 102 that were tested by incorporating in conventional conveying apparatus 100 shown in FIG. 1 are shown as P1, P2 and P3. These driven rollers P1 to P3 are not in the two layer structure, formed 4 mm thick with pure rubber material having a coefficient of dynamic friction 1.0.

According to the results of this test, it is seen that the standard deviations of driven roller P1 with thrusting force by a spring 106 set at 5[N] and driven roller P2 with the thrusting force set at 20[N] were 1.3 to 2 ms, and the normal conveying performance was not obtained. This is considered that the leap-up of driven roller as mentioned above was produced as a result of the thrusting force necessary for conveying postal matters P not given successively.

Further, in the case of driven roller P3 with the thrusting force set at 50[N], the above-mentioned leap-up could be prevented but on the other hand, the thrusting force too high does not accept postal matters P into nip 103, causing the conveying jam.

That is, in order to obtain a good conveying performance without varying the conveying interval, it is important to make driven roller 6 in the above-mentioned two-lay structure and arrange it rigidly by press fitting to driven roller 4 as in conveying apparatus 1 in the first embodiment described above. Further, it is seen that the center distance of driven rollers 6 and 4 is set at an adequate distance and the thrusting force is set at an adequate value.

As shown in FIG. 5 and FIG. 7, in the case of driven rollers S21 to S29 using rubber material having relatively low coefficient of dynamic friction, it is seen that even when thickness of rubber 21 and hardness of sponge 22 were set at almost the same level as those of above-mentioned driven rollers S11 to S19, the standard deviation become large and a value exceeding 1.0 mm is shown for all rollers. That is, if a coefficient of dynamic friction of a driven roller was low, the conveying forces F and F′ from rollers 4 and 6 explained referring to FIG. 4 become weak and a sufficient conveying force cannot be obtained. As a result, a variance in the conveying interval is caused.

It is known that a coefficient of dynamic friction of driven roller 6 varies according to a relative velocity difference with postal matters P. The inventors detected that a good conveying performance can be obtained when rubber material of which coefficient of dynamic friction becomes 0.7 or more at the relative velocity difference below 200 mm/s is used.

In order to accurately convey postal matters P, it is important not to generate a large slip between postal matters P and driven roller 6 as described above. However, it is not possible to create a state not generating a slip entirely between postal matter P and driven roller 6 and it is necessary to consider a certain slip when selecting a coefficient of friction of rubber 21. It is sufficient to consider that a relative velocity between postal matter P and driven roller 6 is 200 mm/s or less and it is confirmed that if a coefficient of dynamic friction more than 0.7 is obtained in this range, the conveying perform is not adversely affected.

Next, using driven rollers S11, S12, S14, S15 and S17 from which the good conveying performance could be obtained as described above, an endurance test was conducted to convey plural postal matters P consecutively for 500 hours using conveying apparatus 1.

As the result of this endurance test, when driven roller S17 of which sponge 22 is harder than other driven rollers was set in conveying apparatus 1, a bearing (not shown) that is retaining driven roller 4 opposing to driven roller S17 in the rotatable state was broken at the time when about 100 hour passed after staring the test. Further, there was caused a problem that postal matters P that are especially thin below 0.2 mm were broken at a rate of 1/10,000. This damage was caused for a reason that sponge 22 is too hard and the shock applied to postal matters P when rushed into nip 5 cannot be reduced.

On the other hand, when driven rollers S11, S12, S14 and S15 were set in conveying apparatus 1, damages of the component units and postal matters P were not recognized. That is, these four driven rollers S11, S12, S14 and S15 satisfied the conditions to display a good conveying performance.

Accordingly, it was revealed that a good conveying performance causing no variance in conveying interval when driven roller 6 satisfying the above-mentioned condition is rigidly arranged to driven roller 4 when postal matters P in different thickness are conveyed successively.

Further, this inventor et al. conducted the endurance test shown below to investigate tear strength and durability of sponge 22. That is, driven rollers S11′, S12′, S14′ and S15′ with Kyowa Giken made LL rubber A type sponge 22′ replaced for sponge 22 of four driven rollers S11, S12, S14 and S15 which could obtain a good conveying performance as described above were prepared. Then, an endurance test was conducted to convey plural postal matters P consecutively for 1,000 hours by incorporating these driven rollers S11′, S12′, S14′ and S15′ in conveying apparatus 1, respectively.

Further, for the purpose of comparison, the 1,000 hour endurance test was conducted at this time for driven rollers S11, S12, S14 and S15 using Kyowa Giken made LL rubber B type sponge 22 (JIS K 6252 Tear Strength; 2 kN/m) described above.

As a result of this endurance test, neither damage of postal matters P nor conveying variance were caused for all driven rollers of both types at the time when 1,000 hours elapsed. That is, for sponges 22 and 22′ investigated in this endurance test, no problem was caused during this 1,000 hour endurance test. However, regarding LL rubber B type sponge 22 made by Kyowa Giken Co. Ltd., cracks were generated on the sponges of driven rollers S11 and S12 at the time when 500 hours passed. On the contrary, no crack was caused on Kyowa Giken Co., Ltd. made LL rubber A type sponge 22′ of all driven rollers after 1,000 hours passed.

Harness of sponges 22 of driven rollers S11 and S12 caused crack is smaller than that of the other same type of driven rollers S14 and S15. When hardness of the sponge is small, tear strength tends to become weak. That is, it can be said that a reason for cracking is tear strength and a sponge having low tear strength is liable to cause crack.

Accordingly, it is seen that durability of sponge 22 of driven rollers can be improved when a sponge of JIS K 6252 tear strength 8 kN/m or above is used. Further, for materials of sponge 22, polyolefin foam material PE-LITE (Trademark) RL Series manufactured by INOAC CORPORATION and Hokushin Corporation made urethane sponge No. 15 are effectively usable.

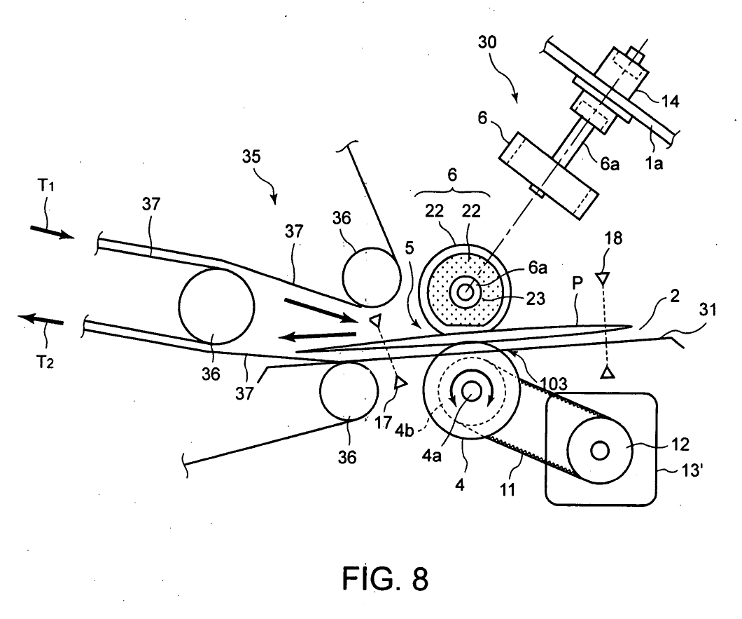

Next, a conveying direction switching apparatus 30 (paper-like material conveying direction switching apparatus) involved in the second embodiment of this invention will be explained referring to FIG. 8. Further, component elements that function similarly to those of conveying apparatus 1 in the first embodiment will be assigned with the same reference numerals and the detailed explanation thereof will be omitted. Further, this conveying direction switching apparatus 30 is to processes postal materials P in different thickness.

Conveying direction switching apparatus 30 has drive rollers 4 and driven rollers 6 which are rotated in the forward and reverse directions by a motor 13′. Rollers 4 and 6 are in the same structure as those in the first embodiment and press fit each other with conveying path 2 put between them. Further, conveying direction switching apparatus 30 has a guide plate 31 extending along the lower surface of conveying path 2 via nip 5 put between two rollers 4 and 6.

Further, conveying direction switching apparatus 30 is provided with a conveying apparatus 35 which feeds a postal matter P toward nip 5 (in the arrow direction T1 in FIG. 8), receives a postal matter P sent out in the reverse direction (in the arrow direction T2) from nip 5 and conveys a received postal matter in the arrow direction T2. Conveying apparatus 35 has plural conveying rollers 36 and plural endless conveying belts 37 stretched by wounding round these conveying rollers 36.

When a postal mater P is sent into the arrow direction T1 by conveying apparatus 35, a postal matter P is rushed into nip 5 between drive roller 4 and driven roller 6. At this time, drive roller 4 is rotating in the clockwise direction and driven roller 6 is rotating in the same direction as drive roller 4.

After postal matters P are rushed into nips 5, drive roller is decelerated at a prescribed timing and postal matter P is stopped. When postal matter P rushes into nip 5, driven roller 6 is elastically deformed and follows postal matter P.

Hereafter, drive roller is reversed, postal matter P pinched and held by nip 5 is accelerated in the arrow direction T2 and transferred to conveying apparatus 35. Thus, the conveying direction of postal matter P is reversed.

Drive roller 4 is so controlled as to repeat the forward and reverse rotations according to the charge timing of postal matters P. Thus, it becomes advantageous to construct the second layer of driven roller 6 using relatively light sponge 22 as in conveying direction switching apparatus in this embodiment. That is, in order to reverse the conveying direction of postal matters P, it is necessary to rotate reverse two rollers 4 and 6 in a moment of time and a small moment of inertia of two rollers 4 and 6 becomes favorable.

In other words, when driven roller 6 is heavy, it becomes a large load when reverse rotating postal matters P and the reaction speed at the time of reverse rotation becomes slow. On the contrary, driven roller 6 in this embodiment is light in weight as the second layer. is constructed using sponge 2 and the moment of inertia can be made small. Thus, a load at the time of rotation can be reduced. In this embodiment, the weight of driven roller 6 is within a range of 20 to 26 g including the weight of core metal 23 and a driven roller can be made to a weight below 75% of a solid rubber roller.

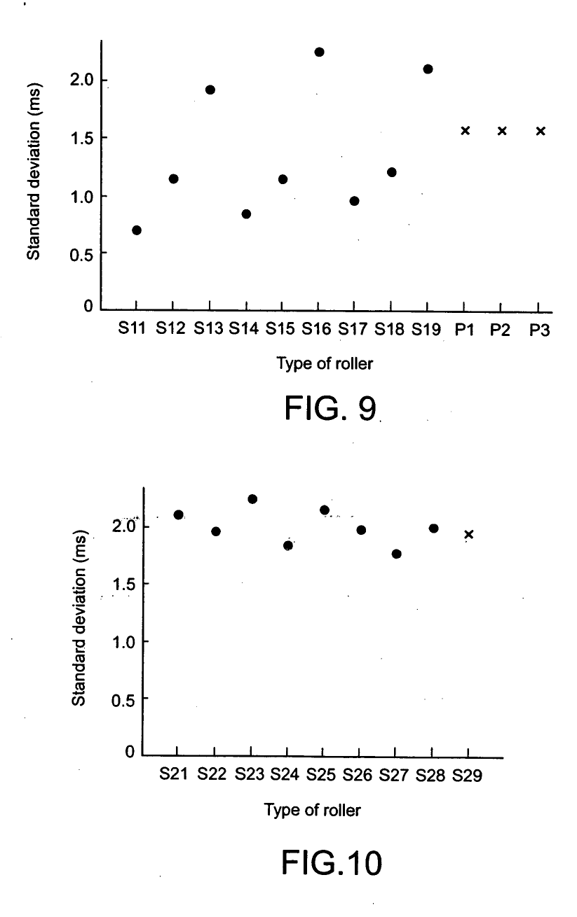

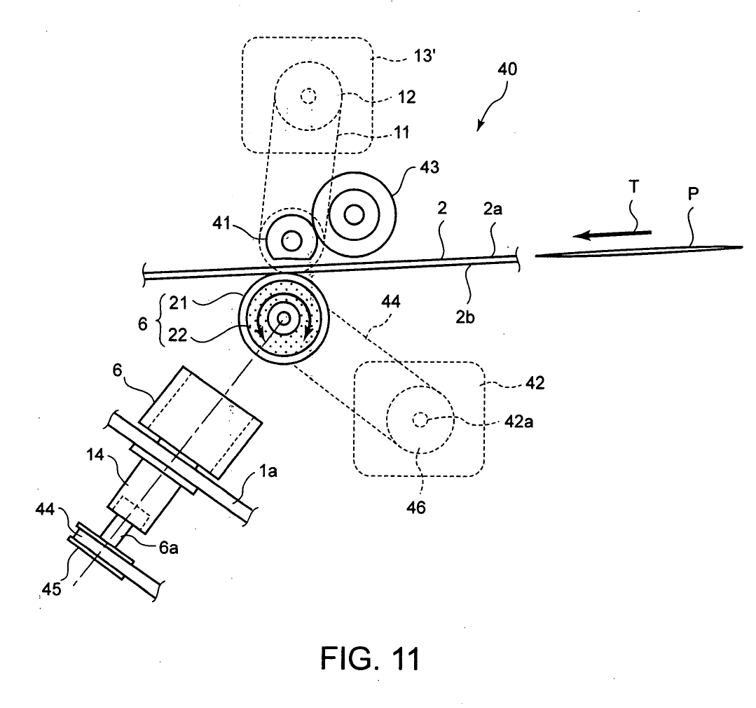

The paper feed test was also conducted on conveying direction switching apparatus 30 of this embodiment by charging plural postal matters P under the same conditions as conveying apparatus 1 in the first embodiment. That is, driven rollers S11 to S19 and S21 to S29 shown in FIG. 5 sere set in conveying direction switching apparatus 30, 1,000 postal matters P in the above-mentioned thickness and weight were charged, and variance in the conveying interval (the standard deviation) of postal matters P was checked. The results are shown in FIG. 9 and FIG. 10.

Hereinafter, the results of this test will be examined.

As shown in FIG. 9, the standard deviations of six driven rollers S11, S12, S14, S15, S17 and S18 are in the range of 0.7 to 1.1 ms and good results are shown. The thickness of rubber 21 of these driven rollers was all below 4 mm. That is, the thickness (15 to 4 mm) is more than 1.8 times against postal matters P in maximum thickness 6 mm and the thickness of rubber 21 is below ½ of the thickness of sponge 22.

In an apparatus to process postal matters P, this type of conveying direction switching apparatus 30 is normally incorporated at one or two points. When the standard deviation is compared with the above-mentioned conveying apparatus 1, the conveying interval is different largely. This is a problem in the structure to reverse postal matters P and a tolerance of the difference in conveying interval may be set larger than that of conveying apparatus 1 equipped with plural conveying direction switching apparatus. Therefore, when the standard deviation is in a range of 0.6 to 1.1 ms as shown by the test result described above, it is considered that a good processing performance is presented.

On the contrary, rubber 21 of driven rollers S14, S16 and S19 is 6 mm thick but the standard deviation was larger than driven rollers S11, S132, S14, S15, S17 and S18. That is, the condition of this invention is not satisfied. In driven rollers S13, S16 and S19, driven rollers were not able to deform following postal matters P when relatively thick postal matters P are conveyed and the conveying interval was varied. Further, as rubber 21 is thick, driven rollers became heavy and the large variance resulted accordingly.

From the above, it is seen that the thickness t2 of sponge 22 more than 1.8 times of the maximum thickness of postal matter P and the thickness t1 of rubber 21 less than ½ of the thickness t2 of sponge 22 are required for obtaining a good reversing performance.

Further, as an example for comparison, the above-mentioned postal matter P feed test was conduced by adopting a structure with driven rollers press fit to drive rollers in the conveying direction switching apparatus likewise conveying apparatus 100 shown in FIG. 1 and Such results shown by P1 to P3 in FIG. 9 were obtained.

According to this test, the normal reversing operation could not be made for all rollers P1 to P3 irrespective of the thrusting force. That is, all rollers P1 to P3 caused the leap-up and the successive conveying force could not be applied to postal matters P, and the jamming resulted.

In other words, it is seen that in order to reverse postal matters P normally, it is important to arrange driven roller 6 rigidly for drive roller 4 in the press fit state likewise paper-like material conveying direction switching apparatus 30 in the second embodiment and it is also important to set driven roller 6 and drive roller 4 at a proper center distance so as to set the thrusting force at a proper value.

Further, as shown in FIG. 10, in the case of driven rollers S21 to S29 using rubber material of relatively low coefficient of dynamic friction, even when the thickness of rubber 21 and hardness of sponge 22 are set at the almost same levels as those of driven rollers S11 ˜S19, the standard deviation becomes large and the values were more than 1.7 ms for all rollers. That is, when the coefficient of dynamic friction of driven roller is low, the conveying forces F and F′ of rollers 4 and 6 become weak and sufficient conveying force is not obtained. Regarding driven roller S29, rubber 21 is thicker than other rollers and its hardness is larger and a slip is produced between rubber 21 and postal matter P and the jamming was caused.

The inventor et al. confirmed that a good reversing performance is obtained when a rubber material of which coefficient of dynamic friction becomes more than 0.7 at a relative velocity difference between driven roller 6 and postal matter P below 200 mm/s is used for rubber 21.

Next, endurance tests to feed plural postal matters P successively for 500 hours were conducted using driven rollers S11, S12, S14, S15, S17 and S18 from which the good reversing performance was obtained as described above.

As the result of this endurance tests, such problems as shown below were caused when driven rollers S17 and S18 using sponge 22 of which hardness is larger than other driven rollers were set in conveying direction switching apparatus 30. That is, when driven roller S17 was used, at the time when about 80 hours passed from starting the test, a bearing (not shown) retaining drive roller 4 opposite to driven roller S17 rotatably was broken. Further, when driven roller S18 was used, the bearing of drive roller 4 was broken at the time when about 60 hours passed from the start of the test. In addition, at this time, especially 0.2˜0.4 mm thick postal matters P were broken at a rate of 1/5,000 postal matters. This is because sponge 22 is too hard to relieve a shock when a postal matter P is rushed into nip 5. On driven rollers S11, S12, S14 and S15, no damage of component units of conveying direction switching apparatus 30 and postal matters P was recognized. In other words, the test result was such that these four driven rollers S11, S12, S14 and S15 satisfy the conditions to display a good reversing performance.

Therefore, it was found that a good reversing performance can be obtained without causing a variance in the conveying interval when driven roller 6 that satisfies the above-mentioned conditions is rigidly arranged to drive roller 4 when postal matters P in different thickness are reversed successively.

Further, the inventor et al. conducted an endurance tests shown below to investigate the relation between tear strength and durability of sponge 22. That is, for 4 driven rollers S11, S12, S14 and S15 from which a good reversing performance was obtained as described above, driven rollers S11′, S12′, S14′ and S15′ with LL rubber A type sponge 22′ manufactured by Kyowa Giken having JIS K 6254 Compression Set less than 4% and JIS K 6152 Tear Strength more than 8 kN/m were prepared. Then, with these driven rollers S11′, S12′, S14′ and S15′ incorporated in conveying direction switching apparatus 30, an endurance test to process plural postal matters P successively for 1,000 hours was conducted for the driven rollers, respectively. Further, for the purpose of comparison, endurance tests for 1,000 hours were also conducted on driven rollers S11, S12, S14 and S15 using an LL rubber B type sponge 22 (with JIS K 6252 Tear Strength; 2 kN/m) manufactured by Kyowa Giken Co., Ltd.

As a result of these endurance tests, any damage of postal matters P and the apparatus was not caused for all driven rollers of both types at the time when 500 hours passed. That is, no problem was caused in the 500 hour endurance tests on sponges 22 and 22′ checked in these endurance tests. However, in connection with Kyowa Giken Co., Ltd. made LL rubber B type sponge 22, cracks were caused on the sponge portions of driven rollers S11 and S12 at the time when 500 hours passed. Further, in connection with these two driven rollers S11 and S12, the roller shape was deformed and the circular shape could not be maintained at the time when 800 hours passed. On the contrary, in connection with Kyowa Giken, Co., Ltd. made LL rubber A type sponge 22′, no crack was generated and no roller deformation was recognized when 1,000 hours passed.

In the case of driven rollers S11 and S12 that were cracked and deformed, the hardness of sponge 22 was smaller than the same type of other rollers S14 and S15. When the hardness of sponge is small, the tear strength also tends to become small. That is, the reason for causing crack and deformation is the tear strength and it can be said that sponge tends to cause crack and deformation when the tear strength is small.

Therefore, from the endurance tests described above, it is seen that durability can be improved when a sponge having JIS K 6252 Tear Strength 8 kN/m or more is used for driven roller sponge 22. Further, as a material of sponge 22, INOAC CORPORATION made polyolefin foam material PE-LITE series, Hokushin Corporation made urethane sponge No. 15, etc. are also effectively usable.

Next, a stamping apparatus 40 (a paper-like stamping apparatus) involved in a third embodiment of this invention will be explained referring to FIG. 3. Further, component elements of this stamping apparatus functioning similarly to conveying apparatus 1 in the above-mentioned first embodiment will be assigned with the same reference numerals and detailed explanation thereof will be omitted. Further, this stamping apparatus is also to process postal matters P in different thickness.

Stamping apparatus 40 has a cylindrical stamp 41 that is rotated by motor 13′ and a platen roller 6 that is rotated by a motor 42. Platen roller 6 has the same structure as driven roller 6 in the first and second embodiments described above except the width (30 mm in this embodiment) aligned with a postmark that is stamped on postal matters P. Cylindrical stamp 41 is rigidly provided rotatably to frame 1a above conveying path 2, and platen roller 6 is rigidly arranged opposing to cylindrical stamp 41 below conveying path 2.

Above conveying path 2, there is an ink supply roller 42 (an ink supply means) provided for supplying ink on the outer surface of cylindrical stamp 41. Ink supply roller 43 retains ink on its outer surface, turns in contact with the outer surface of cylindrical stamp 41 and supplies ink to the outer surface of cylindrical stamp 41.

Rotational shaft 6a of platen roller 6 has a pulley 45 provided to wind an endless timing belt 44 in addition to a housing 14 provided to frame 1a. Timing belt 44 is wound round a pulley 46 fixed to rotational shaft 42a of motor 42. When motor 42 is turned, platen roller 6 is rotated in the conveying direction of postal matters P (the arrow direction T).

Cylindrical stamp 41 and platen roller 6 are rotated in the same direction at the same velocity as postal matters P that are conveyed between cylindrical stamp 41 and platen roller 6 on conveying path 2 in the arrow direction T. Further, conveying belts 2a and 2b are extended along the upper and lower surfaces of conveying path 2 passing through this stamping apparatus 40, and postal matters P are conveyed in the pinched state between conveying belts 2a and 2b.

Cylindrical stamp 41 has the sectional surface formed almost in the D-shape and the outer surface rotating in contact with a postal matter P during the rotation and a notched portion that does not contact postal matters P during the rotation. On the outer surface of cylindrical stamp 41, there is a convex plate (not shown) provided corresponding to a postmark to be stamped on the surfaces of post matters P.

Platen roller 6 is arranged opposite to cylindrical stamp 41 with a specified gap so that it does not contact the outer surface of cylindrical stamp when postal matters P are not conveyed on conveying path 2. Further, the gap between them is set less than the thinnest postal matter out of those to be processed. In this embodiment, this gap was set at 0.05 mm.

When a postal matter P is conveyed in stamping apparatus 40 on conveying path 2, cylindrical stamp 41 and platen roller 6 are rotated at a prescribed timing, and a postmark is stamped on a prescribed position on the surface of a postal matter P. At this time, ink supply roller 43 in contact with cylindrical stamp 41 is rotated corresponding to the rotation of cylindrical stamp 42 and platen roller 6 and supplies ink to the convex plate formed on the outer surface of cylindrical stamp 41.

Further, when postal matters P pass through the gap between cylindrical stamp 41 and platen roller 6, platen roller 6 is elastically deformed corresponding to the thickness of a postal matter P and copes with the change in thickness of postal matters P. Thus, a sufficient thrusting force is always acted to postal matters P in different thickness, and a postmark can be firmly and clearly stamped on the surfaces of postal matters P.

The paper feed tests were also conducted on stamping apparatus 40 in this embodiment under the same conditions as conveying apparatus 1 in the first embodiment and conveying direction switching apparatus 30 in the second embodiment described above by charging plural postal matters P. At this time, the status of postmarks stamped on post matters P were inspected visually by operator and postal matters P which are not normally stamped were counted as being defectively stamped postal matters P and a failure rate was measured. Defective postal matters P are such that those postal matters with partially lacking and/or warped postmarks stamped.

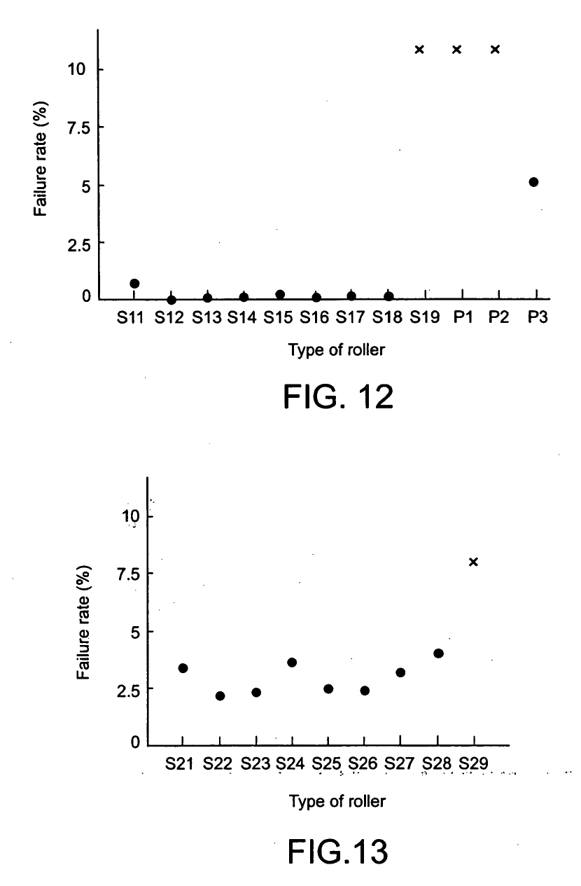

That is, driven rollers S11 to S19 and S21 to S29 shown in FIG. 5 were set in stamping apparatus 40 as platen roller 6 and by charging 1,000 postal matters P having thickness and weight described above, failure rates were checked. Needless to say, all driven rollers were 30 mm wide. The test results are shown in FIG. 12 and FIG. 13. Further, failure rates exceeding 10% were judged not tolerable for practical use and “x” was shown instead of describing data on the graphs.

The test results will be reviewed below.

Failure rates when seven driven rollers S12, S13, S14, S15, S16, S17 and S18 were used was 0% and the result was good as shown in FIG. 12. Further, driven roller S11 caused the defective stamping on thin post matters and a failure rate was 0.5%. This is because its rubber 21 is thicker and harness of sponge 22 is smaller (softer) than other rollers.

On the contrary, driven roller S19 has 6 mm thick rubber 21 and sponge 22 having hardness 50 and does not satisfy the conditions of this invention. Therefore, when driven roller S19 was used, driven roller S19 was not able to deform according to postal matters P and caused the jamming when relatively thick postal matters P were input, and a failure rate when driven roller S19 was used exceeded 10%.

From the above facts, it can be seen that sponge thickness t2 more than 1.8 times of the maximum thick postal matter P and rubber 21 thickness t1 less than ½ of sponge 22 thickness t2 are required for the good postmark stamping.

Further, as a comparison example, the above-mentioned processing tests of postal matters P were conducted by adopting a structure with platen roller 6 press fit to cylindrical stamp 41 to the stamping apparatus likewise conventional conveying apparatus 100 with the results shown by P1 to P3 in FIG. 12.

According to this test results, in connection with all rollers P1 to P3, a good stamping could not be obtained irrespective of the thrusting force of these rollers. That is, when rollers P1 and P2 were used, the rollers leaped up, causing a partially lacked stamping, and a failure rate exceeded 10%. Further, when roller P3 with the increased thrusting force was used, a failure rate was also 5%.

That is, it can be seen that in order to ensure a good stamping of postal matters P, it is important to arrange platen roller 6 in the structure described above against cylindrical stamp 41 firmly with a prescribed gap put between them.

Further, when driven rollers S21 to S29 using a rubber material having a relatively low coefficient of dynamic friction were used as platen roller 6, the failure rates were increased totally as shown in FIG. 13 even when thickness of rubber 21 and hardness of sponge 22. were set at the same values as those of driven rollers S11 to S19 described above. This is because when a coefficient of dynamic friction of the driven roller is low, a sufficient conveying force cannot be obtained between the roller and a postal matter P and a slip is produced between cylindrical stamp 41 and a postal matter P. When a slip is caused between cylindrical stamp 41 and a postal matter P, the postmark is elongated and deformed in the conveying direction of a postal matter P. As for driven roller S29, its rubber 21 is thicker and harder than other rollers, a postal matter 41 could not be accepted between cylindrical stamp 41 and driven roller S29 and the jamming was caused.

The inventor et al. confirmed that a good stamping can be achieved when a rubber material of a relative velocity difference between driven roller 6 and a postal matter P is below 200 mm/s and a coefficient of dynamic friction is more than 0.7 is used for rubber 21.

Next, endurance tests to supply plural postal matters P successively for 500 hours were conducted on driven rollers S11 to S18 which achieved a good stamping as the result of the above-mentioned tests.

As the result of this endurance test, defects shown below were caused when driven rollers S17 and S18 of which sponge hardness was harder than other driven rollers were set in stamping apparatus 40. When driven roller S17 was used, the rotational shaft of cylindrical stamp 41 was broken when about 100 hours passed after starting the test. Further, in the case of driven roller S18, the rotational shaft of cylindrical stamp 41 was broken at about 80 hours after starting the test. At this time, there was caused a problem that especially 0.2 to 0.4 mm thick postal matters P were torn at a rate of 1 per 1,000 postal matters. This is because sponge 22 is too hard and a shock applied to postal matters P when rushed between cylindrical stamp 41 and the driven roller could not be relieved.

Further, when driven rollers S13 and S16 of which rubber 21 was thicker (6 mm) than other rollers were used, the rotational shaft of cylindrical stamp 41 was not broken but 3 to 6 mm thick postal matters P were torn at a rate of 1/5,000 postal matters. This defect was caused because the hardness of driven roller becomes high as a result of the thickness of rubber 21 made thicker. When the endurance tests for successive 500 hours were conducted on driven rollers S11, S12, S14 and S15, no damage was recognized on component units of stamping apparatus 40 and postal matters P. That is, the tests were resulted that these four driven rollers S11, S12, S14 and S15 satisfy the conditions to achieve a good stamping.

Thus, it was revealed that when postal matters P in different thickness are successively conveyed and a postmark is stamped, lacking and deformation of a postmark can be prevented and a good stamping can be achieved by arranging platen roller 6 satisfying the above-mentioned conditions rigidly to cylindrical stamp 41.

Further, the inventor et al. of this invention conducted the endurance test shown below in order to examine the relation between tear strength and durability of sponge 22. That is, for 4 driven rollers S11, S12, S14 and S15 from which a good reversing performance was obtained as described above, driven rollers S11′, S12′, S14′ and S15′ with LL rubber A type sponge 22′ manufactured by Kyowa Giken having JIS K 6254 Compression Set less than 4% and JIS K 6152 Tear Strength more than 8 kN/m were prepared. Then, by incorporating these driven rollers S11′, S12′, S14′ and S15′ in conveying direction switching apparatus 30, endurance tests to process plural postal matters P successively for 1,000 hours were conducted. Further, for the purpose of comparison, endurance tests for 1,000 hours were also conducted on driven rollers S11, S12, S14 and S15 using an LL rubber B type sponge 22 (with JIS K 6252 Tear Strength; 2 kN/m) manufactured by Kyowa Giken Co., Ltd.

As a result of the endurance tests, any damage of postal matters P and the apparatus was not caused for all driven rollers of both types at the time when 500 hours passed. That is, no problem was caused in the 500 hours endurance tests on sponges 22 and 22′ checked in the endurance tests. However, in connection with Kyowa Giken Co., Ltd. made LL rubber B type sponge 22, cracks were caused on the sponge portions of driven rollers S11 and S12 at the time when 500 hours passed. Further, in connection with these two driven rollers S11 and S12, the roller shape was deformed and the circular shape could not be maintained at the time when 700 hours passed and a normal postmark could not be formed on postal matters P 0.3 mm thick or less. On the contrary, in connection with Kyowa Giken Co., Ltd. made LL rubber A type sponge 22′, no crack was generated nor the roller deformation was recognized for all driven rollers when 1,000 hours passed.

In the case of driven rollers S11 and S12 that were cracked and deformed, the hardness of sponge 22 was smaller than the same type of other rollers S14 and S15. When the hardness of sponge is small, the tear strength also tends to become small. That is, the cause for crack and deformation is the tear strength and it can be said that sponge tends to cause crack and deformation when the tear strength is small.

Therefore, from the endurance test described above, it is seen that durability can be improved when a sponge having JIS K 6252 Tear Strength 8 kN/m or more is used for driven roller sponge 22. Further, as a material of sponge 22, INOAC CORPORATION made polyolefin foam material PE-LITE series, Hokushin Corporation made urethane sponge No. 15, etc. are also effectively usable.

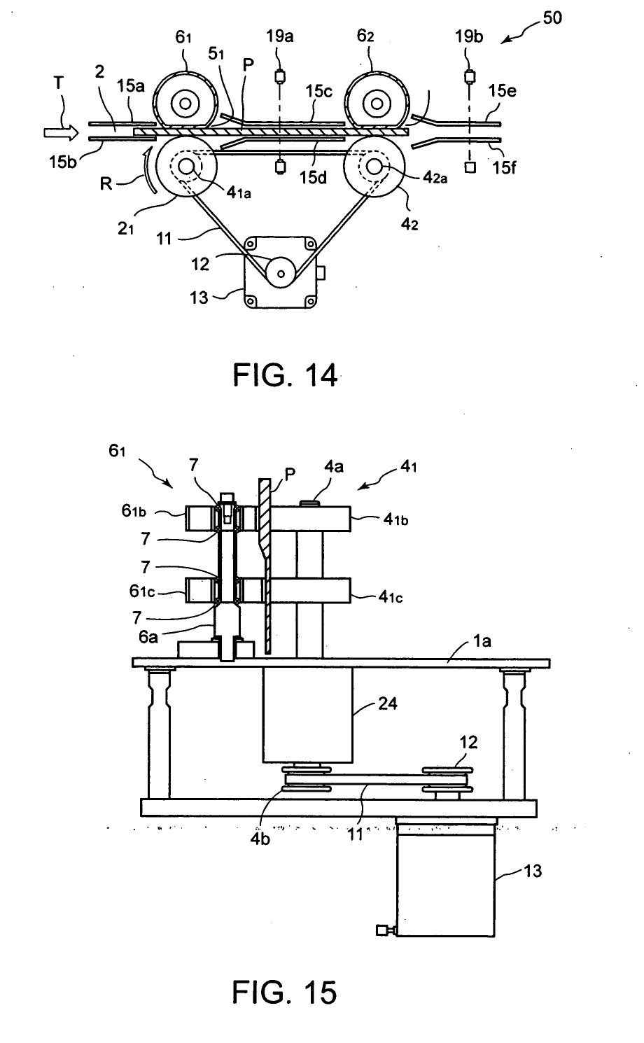

Next, a conveying apparatus 50 involved in the fourth embodiment of this invention will be explained referring to FIG. 14.

Conveying apparatus 50 has conveying path 2 to convey postal matters P in the arrow direction T as shown in FIG. 14. At one side of conveying path 2 (the lower side in FIG. 14), two drive rollers 4₁ and 4₂ are provided along the conveying direction T apart each other. Further, at the positions opposing to two drive rollers 4₁ and 4₂ at the other side of conveying path 2 (the upper side in FIG. 14), two driven rollers 6₁ and 6₂ are provided. These two driven rollers 6₁ and 6₂ are driven in contact with drive rollers 4₁ and 4₂, respectively.

Roller portions of two driven rollers 6₁ and 6₂ described later are formed with elastic deformable material and deformed in contact with roller portions (described later) of corresponding drive rollers 4₁ and 4₂. In other words, conveying path 2 is extending through nip 5₁ between drive roller 4₁ and driven roller 6₁ and nip 5₂ between drive roller 4₂ and driven roller 6₂. Further, two drive rollers 4₁ and 4₂ are in the same structure and two driven rollers 6₁ and 62 are in the same structure. Therefore, one of the will be explained below as a representing sample.

Drive roller 4₁ (explained as a representative roller) has a rotational shaft 4a extending in the almost vertical direction and two roller portions 4₁b and 4₁c as shown in FIG. 15. Two roller portions 4₁b and 4₁c are fixed to rotational shaft 4a by separating to the upper and lower sides along rotational shaft 4a. The base portion of rotational shaft 4a is rotatably fixed to frame 1a of conveying apparatus 50. That is, housing 24 with plural bearings (not shown) incorporated is fixed to frame 1a and rotational shaft 4a is extending by passing through this housing 24.

To the base portion of rotational shaft 4a projecting from housing 24, a pulley 4b is attached. Endless timing belt 11 is wound round pulley 4b and stretched between pulley 4b and pulley 12 attached to the rotational shaft of motor 13 fixed to frame 1a. This timing belt 11 is also wound round a pulley (not shown) attached to rotational shaft 4₂a of other drive roller 4₂. Then, when motor 13 is driven, two drive rollers 4₁ and 4₂ are rotated synchronously at a prescribed velocity in the arrow direction R shown in FIG. 14.

On the other hand, driven roller 6₁ (explained as a representative sample) has rotational shaft 6a fixed to frame 1a. This rotational shaft 6a does not rotate against frame 1a. Rotational shaft 6a is provided with two rollers 6₁b and 6₁c formed with elastic deformable material apart in the axial direction and attached to rotational shaft 6a rotatable independently, respectively. That is, two roller portions 6₁b and 6₁c are attached to rotational shaft 6a via two bearings 7, respectively. Further, two roller portions 6₁b and 6₁c are positioned to contact two roller portions 4₁b and 4₁c of opposing drive roller 4₁.

The center distance between drive roller 4₁ and driven roller 6₁ is so set that roller portions 4₁b, 6₁b and 4₁c, 6₁c are press contacted. That is, rotational shafts 4a and 6a of two rollers 4₁ and 6₁ are attached to frame 1a at the fixed positions. Therefore, by elastically deforming the roller portions 6₁b and 6₁c of driven roller 6₁, the thrusting force is produced between them. In addition, by elastically deforming roller portions 6₁b and 6₁c of driven roller 6₁, postal matters P are allowed to pass between them.

Returning to FIG. 14, there are plural guide plates 15a to 15f at both sides of conveying path 2. That is, there are two guide plates 15a and 15b opposing to each other with conveying path 2 put between them at the upstream side in the conveying direction from nip 5₁ between drive roller 4₁ and driven roller 6₁. Also, there are two guide plates 15c and 15d opposing to each other with conveying path 2 between them and between nip 5₁ and nip 5₂ between drive roller 4₂ and driven roller 6₂. At the downstream side in the conveying direction from this nip 5₂, there are provided two guide plates 15e and 15f opposing to each other with conveying path 2 put between.

Further, on the conveying path between two nips 5₁ and 5₂ and on the conveying path at the downstream side of nip 5₂, there are provided sensors 19a and 10b for detecting passage of postal matters P. Sensors 19a and 19b (hereinafter, collectively called sensor 19) has a light emission portion and a light receiving portion according to the positions at both sides of conveying path 2 and the optical axis extending between them at a position intersecting conveying path 2.

Driven rollers 6₁ and 6₂ are in the same structure as those in the first embodiment and therefore, the explanation thereof will be omitted.

In conveying apparatus 50 involved in the fourth embodiment of this invention, the apparatus is in the two-layer structure and has driven rollers 6₁ and 6₂ provided in sponge 22 likewise the first embodiment. Further, hardness and thickness of sponge 22 become requisite conditions for obtaining deforming performance following postal matters P and adequate thrusting force by mutual interaction. When hardness is too hard or thickness is too thin, the following deformation may become difficult, defective conveying may result or drive roller 4₁ and 4₂ can be damaged. That is, in order for normally conveying postal matters P by the above-mentioned conveying apparatus 50, it is necessary to set coefficients of dynamic friction, hardness and thickness of driven rollers 6₁ and 6₂ at proper values.

Next, the operation of conveying apparatus 50 described above to convey postal matters P in non-uniform thickness will be explained, especially by noting the behavior of two rollers 4₁ and 6₂. Further, a case to convey a postal matter P in non-uniform thickness will be explained. That is, the postal matter is thicker at the side clamped and conveyed by two rollers 4₁b and 6₁b at the upper side along the axial direction in FIG. 15 than the side clamped and conveyed by two rollers 4₁c and 6₁c at the lower side.

As described above, roller portions 6₁b and 6₁c of driven roller 6₁ are formed with elastically deformable material and the deforming amount is variable according to thickness of postal matter P passing through nip 5₁ between roller portions 4₁b and 4₁c of drive roller 4₁. In this example, the deforming amount of roller portion 6₁b to clamp and convey the thicker side of postal matter P is larger than roller portion 6₁c to clamp and convey the thinner side. In other words, the apparent radius of roller portion 6₁b becomes smaller than the apparent radius of roller portion 6₁c in this case.

Therefore, when a postal matter P in non-uniform thickness is conveyed on conveying path 2 passes through nip 5₁ as described above, the angular velocity of roller portion 6₁b in small radius becomes larger than the angular velocity of roller portion 6₁c in large radius. That is, the angular velocity of roller portion 6₁b in small radius becomes larger because the running velocities of the outer surfaces of roller portions 61b and 61c to rotate in contact with postal matter P are the same. On the other hand of different angular velocities, the running velocities of the outer surfaces, that is, peripheral velocities of roller portions 6₁b and 6₁c become the same.

On the contrary, when roller portions 6₁b and 6₁c are fixed to rotational shaft 6a, angular velocities of rollers 6₁b and 6₁c become physically uniform and therefore, a difference is produced in peripheral velocities of two roller portions 6₁b and 61c in different radius. Thus, when a difference is produced in the peripheral velocities of two roller portions 6₁b and 6₁c, a difference is produced in the conveying velocities to convey postal matters P, and not only postal matters P may be wrinkled but also may be torn in the worst case.

Therefore, roller portions 6₁b and 6₁c are attached to rotational shaft 6a rotatable independently in this embodiment. As a result, the angular velocities of roller portions 6₁b and 6₁c can be made different so as to cope with postal matters P in non-uniform thickness.

In other words, according to this embodiment, two roller portions 6₁b and 6₁c provided to driven roller 6₁ coaxially are made rotatable independently from rotational shaft 6a. Therefore, even when postal matters P in non-uniform thickness are conveyed, the postal matters P can be conveyed steadily without causing wrinkle, skew, tear and other defects.

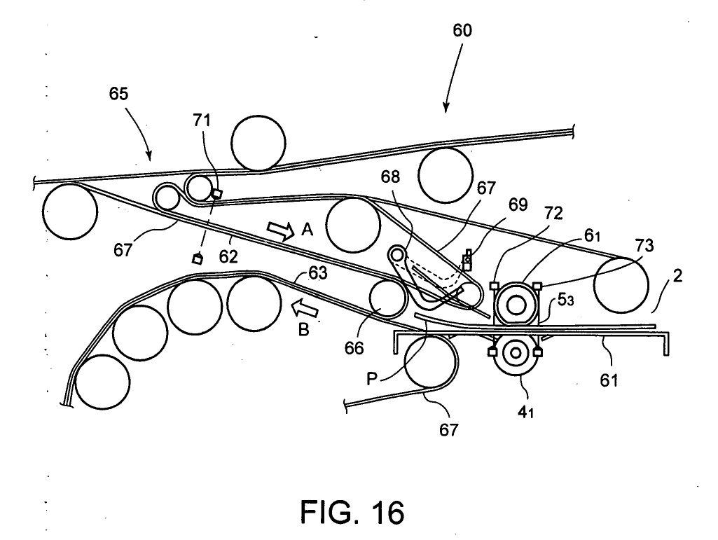

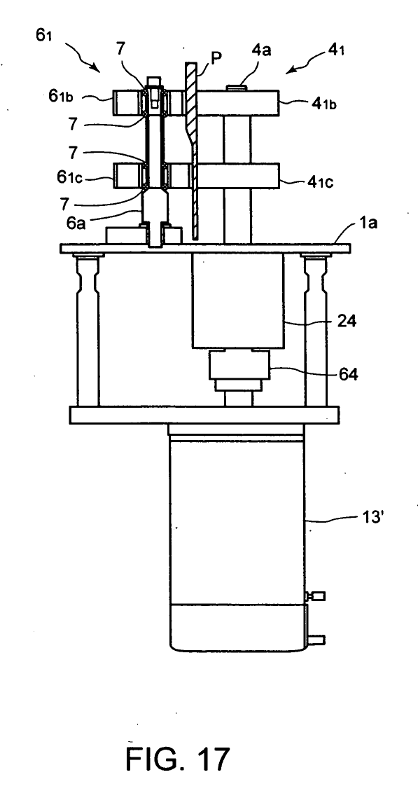

Next, a paper-like material conveying direction switching apparatus 60 (hereinafter, simply referred to as conveying direction switching apparatus 60) involved in a fifth embodiment of this invention will be explained referring to FIG. 16 and FIG. 17. FIG. 16 is a pan view showing the schematic structure of conveying direction switching apparatus 60 and FIG. 17 shows a side view of conveying direction switching apparatus 60 viewed from the direction to convey postal matters P (the arrow direction A in FIG. 16). Further, the component members which function similarly to those of conveying apparatus 50 in the fourth embodiment described above will be assigned with the same reference numerals and the detailed explanation thereof will be omitted here.

This conveying direction switching apparatus 60 is to detect positions of stamps pasted on postal matters P in advance and reverse the conveying directions of postal matters P based on the detected results in order to make the directions and two sides uniform.

Conveying direction switching apparatus 60 has drive roller 4₁ and driven roller 6₁ that are rotated both in the forward and reverse directions by motor 13′ (shown in FIG. 17). In this embodiment, the rotational shaft of motor 13′ is directly connected to rotational shaft 4a of drive roller 4₁ through a coupling 64. Rollers 4₁ and 6₁ are in the same structure as those in the fourth embodiment described above and fitted each other with pressure through conveying path 2. In addition, conveying direction switching apparatus 60 has a guide plate 61 extending along the lower surface side of conveying path 2 through a nip 5₃ between two rollers 4₁ and 6₁.

Further, conveying direction switching apparatus 60 has a conveying belt 62 to send postal matters P in the arrow direction A in FIG. 17 toward nip 5₃ and a carry-out path 63 to send out postal matters P in the reverse direction from nip 53, that is, in the arrow direction B in FIG. 17. That is, conveying direction switching apparatus 60 is equipped with a conveying apparatus 65 which conveys postal matters P in the arrow direction A through conveying belt 62 and convey postal matters P in the arrow direction B through carry-out path 63. Conveying apparatus 65 has plural conveying rollers 66 and plural endless conveying belts 67 that are extended by wounding round these conveying rollers 66.

Further, there is a sensor 71 on conveying belt 62 to detect postal matters P passing through it likewise the fourth embodiment described above. This sensor 71 detects a length of a postal matter P along the conveying direction based on a time of postal matter P when its front end in the conveying direction passes the sensor till its rear end passes the sensor. That is, this sensor 71 is provided for obtaining deceleration, stopping and acceleration of drive roller 4₁.

Further, before and after nip 5₃, there are sensors 72 and 73 provided, respectively. These two sensors 72 and 73 detect presence of postal matters P in nip 5₃.

Conveying direction switching apparatus 60 described above operates as shown below.

When a postal matter P is conveyed in the arrow direction A through conveying belt 62 by conveying apparatus 65, passage of postal matter P is detected by sensor 71 and a length along the conveying direction is detected and then, the front end of the postal matter P is rushed into nip 5₃ between drive roller 41 and driven roller 6₁. At this time, driven roller 6₁ is rotating in the same direction of drive roller 4₁. When a postal matter P passes through nip 5₃, roller portions 6₁b and 6₁c of driven roller 6₁ are elastically deformed following the postal matter P.

Then, after a postal matter P rushes into nip 5₃, drive roller 4₁ is decelerated at a prescribed timing and a postal matter P is stopped. This state is shown in FIG. 16. Hereafter, a lever 68 is turned to a position shown by a solid line in FIG. 16 by a drive apparatus (not shown) and strikes the left end portion of a postal matter P that is kept stopped. Hereafter, lever 68 restores to its home position (a position shown by a broken line) by a sensor 69. Thus, the end portion is directed downward to prepare for the inversion action.

Hereafter, drive roller 4₁ is reversed, a postal matter P in the state clamped and stopped by nip 5₃ is accelerated in the arrow direction B, is turned over to conveying apparatus 65 and carried out through carrying out path 63. The conveying direction of a postal matter P is thus reversed.

As described above, drive roller 4₁ is so controlled as to repeat the normal and reverse rotations according to a charging timing of postal matters P. Therefore, it becomes advantageous to construct the second layer of roller portions 6₂b and 6₁c of driven roller 61 with relatively light sponge 22 as in conveying direction switching apparatus 60 in this embodiment. That is, to reverse the conveying direction of postal matters P, it is necessary to reverse two rollers 4₁ and 6₁ in a moment and the moment of inertia of two rollers 4₁ and 6₁ in small will become advantageous.

In other words, when driven roller 6₁ is heavy, it becomes a large load when postal matters P are reversed and the reaction velocity at the time of reversing becomes slow. On the contrary, drive roller 6₁ in this embodiment becomes light in weight for the second layer constructed with sponge 22 and the moment of inertia can be made small. Thus, a load at the time of rotation can be reduced. In this embodiment, the weight of driven roller 6₁ is in a range of 20 to 26 g including the weight of core metal 23 and when compared with driven roller 56₁ that is made a solid rubber roller, the weight could be suppressed to below 75% of it.

Further, in this embodiment two roller portions 6₁b and 6₁c of driven roller 6₁ are attached to rotational shaft 6a fixed to frame 1a independently rotatable through two bearings, respectively as shown in FIG. 17. Therefore, in this embodiment, the effects similar to those in the fourth embodiment described above are obtained. So, it is possible to reverse the conveying direction of postal matters P certainly without causing wrinkle, skew, tear or other damages on postal matters P.

In the embodiments described above, two roller portions 6₁b and 6₁c mounted along rotational shaft 6a of driven roller 6₁ are explained. However, more than 3 roller portions may be attached to one rotational shaft or one roller portion only can be attached. When only one roller portion is attached to one rotational shaft, the rotational shaft may be attached rotatably to a frame.

Further, because plural roller portions of driven roller 6₁ are attached rotatably independently, roller portions to be attached to different rotational shafts are not necessarily in the same diameter. Furthermore, the attaching positions of drive roller 4₁ and driven roller 6₁ are properly changeable.

In the embodiments described above, this invention applied to an apparatus to process postal matters P in different thickness is explained. However, not limiting to the embodiments described above, this invention is applicable to apparatus for processing various forms including bankbooks, etc. in different thickness.

Further, materials and bonding agents used for the layers of driven rollers 6, 6₁ and 6₂ are not limited to those described in the above embodiments but are optionally changeable when the conditions described in the claims are satisfied.

As explained in the above, a paper-like material conveying apparatus, paper-like material conveying direction switching apparatus and paper-like material stamping apparatus of this invention are in the structures and have actions as described above and are capable of coping with paper-like materials in different thickness such as postal matters, bankbooks, etc. and displaying a good processing performance.

What is claimed is:

1. A paper-like material conveying apparatus comprising:
a drive roller which is given with a driving force, rotated and driven; and
a driven roller arranged rotatably following the rotation of the drive rollers, the driven roller including a first layer formed with a solid elastic material that is in contact with the drive roller and a second layer formed with a foam elastic material that is formed at the inside from the first layer,
wherein paper-like materials conveyed into the nip between the drive roller and the driven roller are pinched, conveyed and carried out.

2. The paper-like material conveying apparatus according to claim 1, wherein thickness of the first layer is below ½ of that of the second layer, a coefficient of dynamic friction between the first layer and paper-like materials is more than 0.7 at less than a relative velocity difference 200 mm/s, a compression set of the second layer is below 5%, hardness of the second layer is below 40 at least at either Asker C hardness or JIS K 6253 E type hardness, and thickness of the second layer is more than 1.8 times of the most thick paper-like material.

3. The paper-like material conveying apparatus according to claim 2, wherein tear strength of the second layer is above 6 kN/m at JIS K 6252 (ISO 34-1,34-2).

4. A paper-like material conveying direction switching apparatus comprising:
a drive roller which is given with a drive force, rotated and driven in both the forward and reverse directions; and
a driven roller arranged rotatably following the rotation of the drive rollers, the driven roller including a first layer formed with a solid elastic material that is in contact with the drive roller and a second layer formed with a foam elastic material that is formed at the inside from the first layer,
wherein paper-like materials in non-uniform thickness conveyed into the nip between the drive roller and the driven roller are pinched, conveyed and stopped and then, the drive roller is counter-rotated and the paper-like materials are carried out in the reverse direction.

5. The paper-like material conveying direction switching apparatus according to claim 4 further comprising:
a conveying apparatus to convey paper-like materials into the nip, receive paper-like materials carried out from the nip and convey in the counter-direction.

6. The paper-like material conveying direction switching apparatus according to claim 4, wherein thickness of the first layer is below ½ of that of the second layer, a coefficient of dynamic friction between the first layer and paper-like materials is more than 0.7 at less than a relative velocity difference 200 mm/s, a compression set of the second layer is below 5%, hardness of the second layer is below 40 at least at either Asker C hardness or JIS K 6253 E type hardness, and thickness of the second layer is more than 1.8 times of the most thick paper-like material.

7. The paper-like material conveying direction switching apparatus according to claim 6, wherein tear strength of the second layer is above 6 kN/m at JIS K 6252 (ISO 34-1,34-2).

8. A paper-like material stamping apparatus comprising:
a cylindrical stamp having a convex plate on the outer surface, which is given with a driving force and rotates;
an ink supply portion to supply ink to the outer surface of the cylindrical stamp; and
a platen roller arranged on the outer surface of the cylindrical stamp in the non-contact state via a prescribed gap, the platen roller including a first layer formed with a solid elastic material and a second layer formed with a foam elastic material that is formed at the inside from the first layer, and the platen roller being given with a driving force and rotated in the same direction as the cylindrical stamp,
wherein a mark is stamped on the surfaces of paper-like materials in non-uniform thickness carried into the gap by contacting and rotating the cylindrical stamp thereon.

9. The paper-like material stamping apparatus according to claim 8, wherein the gap is smaller than the thickness of the thinnest paper-like material.

10. The paper-like material stamping apparatus according to claim 8, wherein thickness of the first layer is below ½ of that of the second layer, a coefficient of dynamic friction between the first layer and paper-like materials is more than 0.7 at less than a relative velocity difference 200 mm/s, a compression set of the second layer is below 5%, hardness of the second layer is below 40 at least at either Asker C hardness or JIS K 6253 E type hardness, and thickness of the second layer is more than 1.8 times of the most thick paper-like material.

11. The paper-like material stamping apparatus according to claim 8, wherein tear strength of the second layer is more than 6 kN/m at JIS K 6252 (ISO 34-1, 34-2).

12. A paper-like material conveying apparatus comprising:
plural drive rollers to contact the same surfaces of paper-like materials taken out on a conveying path and rotate in the conveying direction at the same peripheral velocity; and
plural driven rollers rigidly arranged in contact with plural drive rollers rotatably following the rotation of the drive rollers, respectively through the conveying path and allow to accept paper-like materials conveyed into nips between the driven rollers and the opposed drive rollers by elastically deforming and rotate independently each other.

13. The paper-like material conveying apparatus according to claim 12 further comprising:
a frame to which rotational shafts of the plural drive rollers and rotational shafts of the plural driven rollers are attached rigidly.

14. The paper-like material conveying apparatus according to claim 13, wherein the plural driven rollers have rotational shafts fixed to the frame rotatably independently to the rotational shafts.

15. The paper-like material conveying apparatus according to claim 14, wherein the plural driven rollers are attached coaxially apart in the direction of the rotational shaft.

16. The paper-like material conveying apparatus according to claim 13, wherein the plural drive rollers are attached coaxially apart in the direction of the rotational shaft.

17. The paper-like material conveying apparatus according to claim 12, wherein the plural driven rollers are in the dual layers structure including a first layer formed with a solid elastic material and a second layer formed with a foam elastic material that is formed at the inside from the first layer.

18. A paper-like material conveying direction switching apparatus comprising:
plural drive rollers which contact the same surfaces of paper-like materials taken out on a conveying path and rotate in the same direction at the same peripheral velocity; and
plural driven rollers which are arranged rigidly to contact the plural drive rollers through the conveying path, rotatably following the rotation of the drive rollers, allow to accept paper-like materials to the nips between the driven rollers and the opposed drive rollers by elastically deforming and rotate each other independently,
wherein paper-like materials conveyed into the plural nips are conveyed while pinched and stopped and then, the plural drive rollers are counter-rotated and the paper-like materials are carried out in the reverse direction.

19. The paper-like material conveying direction switching apparatus according to claim 18 further comprising:
a frame to which rotational shafts of the plural drive rollers and rotational shafts of the plural driven rollers are attached rigidly.

20. The paper-like material conveying direction switching apparatus according to claim 19, wherein the plural driven rollers have rotational shafts fixed to the frame rotatably independently to the rotational shafts.

21. The paper-like material conveying direction switching apparatus according to claim 20, wherein the plural driven rollers are attached coaxially apart in the direction of the rotational shaft.

22. The paper-like material conveying direction switching apparatus according to claim 19, wherein the plural drive rollers are attached coaxially apart in the direction of the rotational shaft.

23. The paper-like material conveying direction switching apparatus according to claim 18, wherein the plural driven rollers are in the dual layers structure including a first layer formed with a solid elastic material and a second layer formed with a foam elastic material that is formed at the inside from the first layer.
